(19) United States
(12) Patent Application Publication
(10) Pub. No.: US 2015/0348435 A1
(43) Pub. Date: Dec. 3, 2015

(54) METHODS AND APPARATUSES FOR COMMUNICATION CHANNEL COMPONENT SELECTION

(71) Applicant: Panduit Corp., Tinley Park, IL (US)

(72) Inventor: Kevin R. Hogan, North Aurora, IL (US)

(73) Assignee: PANDUIT CORP., Tinley Park, IL (US)

(21) Appl. No.: 14/726,661

(22) Filed: Jun. 1, 2015

Related U.S. Application Data
(60) Provisional application No. 62/006,586, filed on Jun. 2, 2014.

(51) Int. Cl. G09B 19/00

(52) U.S. Cl. CPC G09B 19/00

(57) ABSTRACT

The present invention generally relates to the field of fiber optics, and more particularly to methods, systems, and apparatuses used to help ensure appropriate selection of connectivity components to provide correct polarity. In an embodiment, the present invention is a deck of cards for implementing a communication channel link. The deck includes a plurality of recipe cards, each of the plurality of recipe cards including an overview of the communication channel link, a card ID string, and a polarity total; and a plurality of component cards, each of the plurality of component cards including a card ID number, a product ID, and a polarity counter; where the card ID string comprises the card ID numbers of at least some of the plurality of component cards.

### CROSS-REFERENCE TO RELATED APPLICATIONS

This application claims the benefit of U.S. Provisional Patent Application No.: 62/006,586, filed on Jun. 2, 2014, which is incorporated herein by reference in its entirety.

### FIELD OF INVENTION

The present invention generally relates to the field of fiber optics, and more particularly to methods, systems, and apparatuses used to help ensure appropriate selection of connectivity components to provide correct polarity.

### BACKGROUND

In fiber optic communication, signals are typically transmitted between transceivers which include signal emitting transmitters (e.g., LEDs, VCSELs, or other optical signal generators) and signal sensing receivers (e.g., various types of photodiodes or other types of photodetectors). For a signal to originate at one transceiver and to properly be received on an opposite end of the communication link, it is essential that the optical waveguide which couples to the signal-originating transmitter be routed to an appropriate signal-sensing receiver. This scenario avoids routing of a waveguide between two transmitters or between two receivers, and is generally referred to as fiber polarity management within the optical fiber art.

While in a simple scenario where two duplex transceivers are directly connected via a single patch cord confusion may be avoided rather easily, fiber connectivity within data centers, enterprise buildings, university campuses, or other types of networking environments is rarely that simple. Instead, connections are typically made between a considerable number of single-fiber, duplex, and multi-fiber transceivers all being routed through one or more interconnection modules such as patch panels, trunk cables, harnesses, cassettes, hydra cables, and others. In addition, multiple methods of maintaining polarity can be employed. As a result, the difficulty of ensuring proper polarity increases significantly.

Furthermore, besides installers who are tasked with the specific job of installing optical connectivity, those who are responsible for providing parts to the installers can also find themselves in a challenging situation when determining which parts are needed for ensuring appropriate polarity. Incorrect sourcing of connectivity components can lead to increased downtime, incorrect installations, malfunctioning communication links, and ultimately a loss in revenue.

Thus, there is a need for methods, apparatuses, and systems which help ensure proper selection and/or installation of components when implementing fiber optic connectivity links.

### SUMMARY

Accordingly, at least some embodiments of the present invention are directed towards methods, apparatuses, and systems which help ensure proper selection and/or installation of components when implementing fiber optic connectivity links.

In an embodiment, the present invention is a deck of cards for implementing a communication channel link. The deck includes a plurality of recipe cards, each of the plurality of recipe cards including an overview of the communication channel link, a card ID string, and a polarity total; and a plurality of component cards, each of the plurality of component cards including a card ID number, a product ID, and a polarity counter; where the card ID string comprises the card ID numbers of at least some of the plurality of component cards.

In another embodiment, the present invention is a method of selecting components for a communication channel link. The method includes the step of selecting the communication channel link from a presented plurality of available communication channel links. The method also includes the step of associating the selected communication channel link with a card ID string, the card ID string including card IDs of a plurality of component cards, each of the plurality of component cards including at least some information related to at least one of the components and a polarity counter. The method also includes the step of compiling the plurality of component cards. And the method also includes the step of selecting the components from the plurality of component cards.

These and other features, aspects, and advantages of the present invention will become better-understood with reference to the following drawings, description, and any claims that may follow.

### BRIEF DESCRIPTION OF THE DRAWINGS

FIGS. 1A-1D illustrate a series (e.g., a deck) of cards according to an embodiment of the present invention.

FIG. 2 illustrates a recipe card according to an embodiment of the present invention.

FIG. 3 illustrates a component card according to an embodiment of the present invention.

FIG. 4 illustrates a flow chart representative of a method of implementing the present invention according to an embodiment.

FIG. 5 illustrates a set of component cards which correspond to the card ID string of the recipe card shown in FIG. 2.

FIG. 6 is an exemplary fiber optic communication channel.

### DETAILED DESCRIPTION

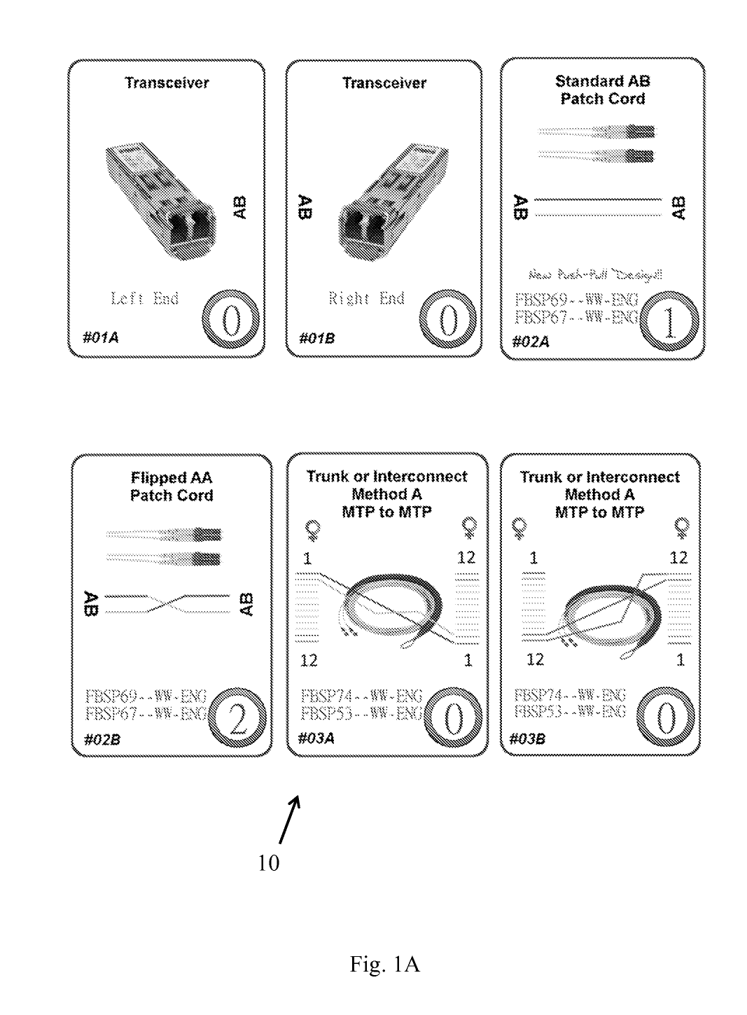

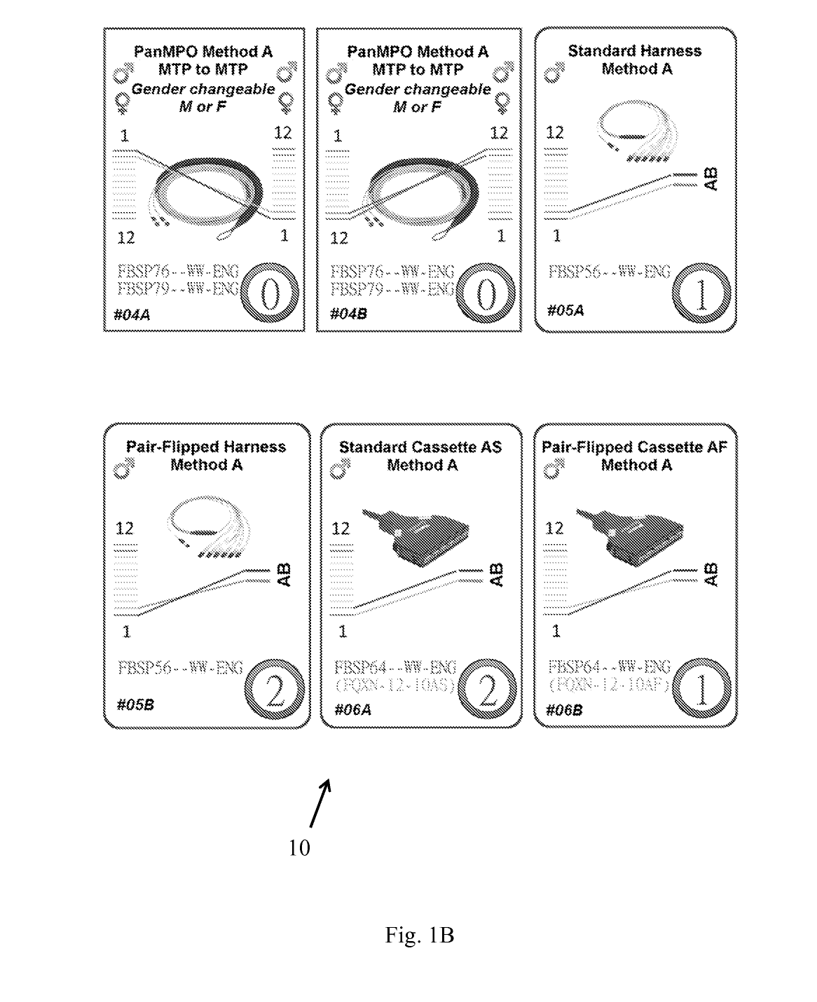

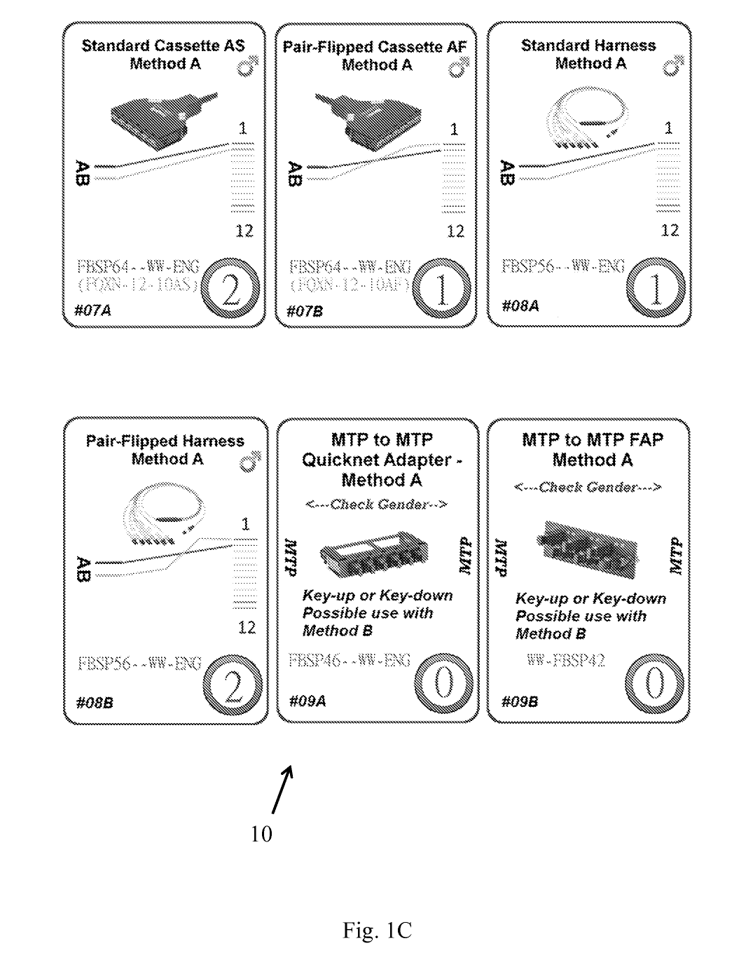

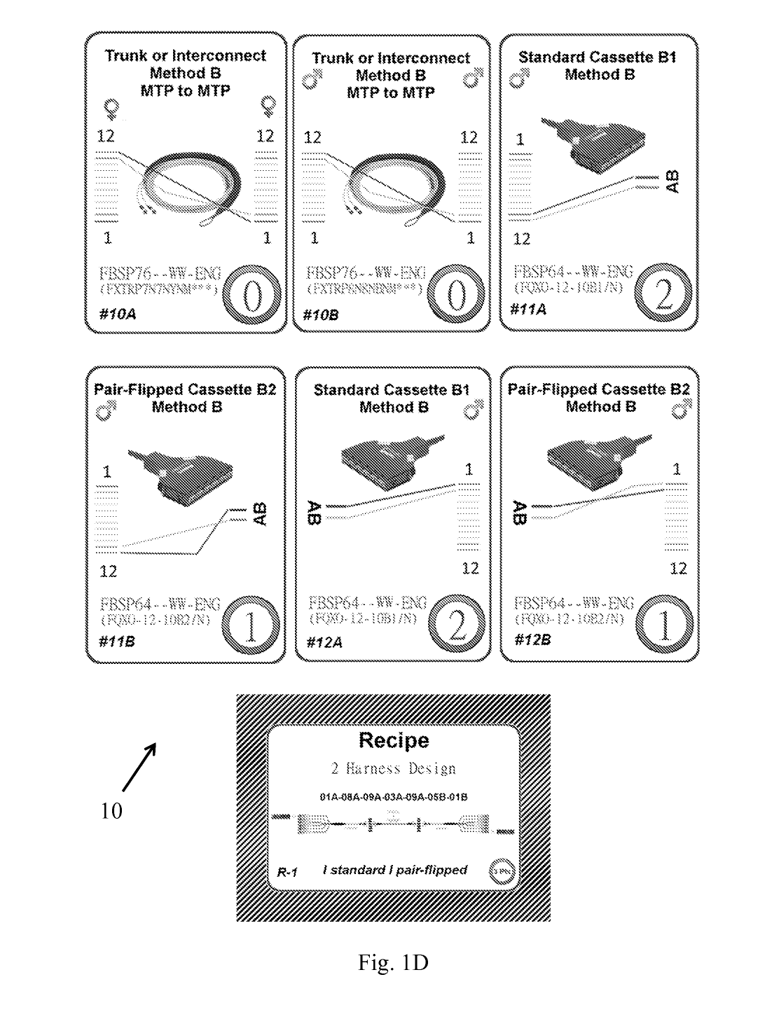

An exemplary embodiment of the present invention is shown in FIGS. 1A-1D. In this embodiment, the present invention includes a series of cards 10 which are used to help determine appropriate part numbers for various optical interconnection schemes. The illustrated embodiment shows the series of cards as being similar to a set of commonly known playing cards. However, as used herein, the term “cards” is not intended to be limiting of a form or shape, and should instead be understood to refer to any medium (paper, plastic, electronic, or other, in any desired shape) which can be used to show or convey some information.

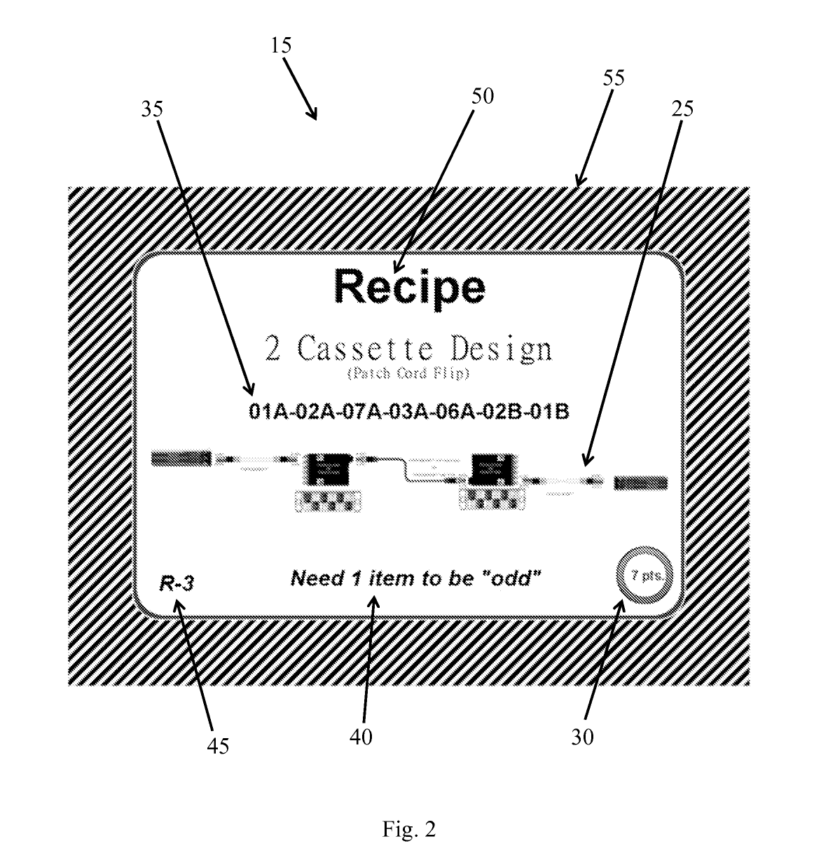

The series of cards (which may be referred to as a “deck”) 10 includes recipe cards 15, and component cards 20. The recipe cards 15, as shown in FIG. 2, include an overview 25 of the communication channel from one end to another. This is a general overview of all the components involved in the communication link between two transceivers and it can be a graphical depiction of the link which shows individual parts of the channel. The recipe cards 15 further include a polarity total 30 which is a number used for verification of accuracy of the selected components. The use of the polarity total 30 will become more-clear later in the specification. The recipe cards 15 also include a card ID string 35 which identifies a series of card IDs that are needed to assemble the channel link shown in the respective recipe card.

In addition, the recipe cards 15 can include a note 40 to a user, a card ID 45 which may be referenced when implementing another card ID string, a card title 50, and a predetermined background color 55 to help differentiate recipe cards from other cards.

Recipe cards 15 can be employed by a user to efficiently and effectively identify the various components needed for a particular channel link. For example, looking at a series of different recipe cards a user may identify a particular channel link that he or she is interested in implementing. This can be aided by the graphical overview 25 of the channel. Once a particular channel link is identified, the user then refers to the card ID string 35 to identify all the component cards that need to be referenced to compile a complete list of components to implement the selected channel link.

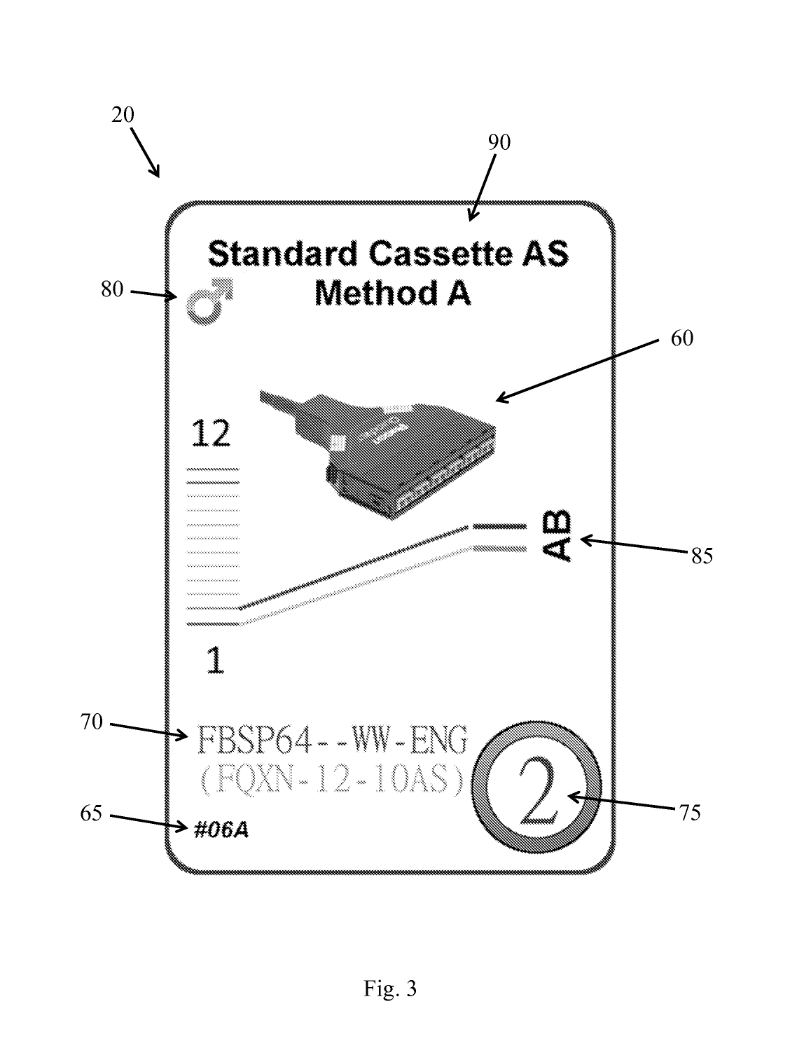

FIG. 3 illustrates an example of a component card 20. Component cards include information related to product (e.g., a cassette, a hydra cable, a patch panel, a patch cable, a transceiver, and so on). In particular, the cards 20 include a product descriptor 60 which can be a graphical depiction of a particular component. The component cards 20 also include a card ID number 65 which provides a quick and efficient means for identifying a particular component card. The card ID number is referenced by the user in connection with locating various cards listed in the card ID string 35. The component cards 20 further include a manufacturer product ID 70 which is typically a part number or a specification sheet number. The product ID 70 should allow a user to directly (e.g., a part number) or indirectly (e.g., a product specification sheet) identify a particular product from within a manufacturer's catalog or database. The product ID 70 can also include a QR code to enable a user to easily and quickly link to a desired website (e.g., manufacturer's or distributer's specific website for the components to which a respective component card relates). In addition, component cards 20 include a polarity counter 75 which assigns a numerical value (e.g., 0, 1, or 2) to each component card. Once a complete channel (as dictated by the card ID string 35 on any particular recipe card 15) is compiled, the sum of the polarity counters can be used to determine the accuracy of polarity. The use of this feature will be explained in more detail later in the specification.

The component cards 20 can also include a gender symbol 80. Since certain components (such as certain MTP components) can have either a male or a female connector, a male-to-male or a female-to-female arrangement may be problematic. The gender symbol 80 can be used to ensure that a male-to-male or a female-to-female scenario is avoided. It is important to note that in some cases, the gender of the components can be varied between the male and female states. In that case, the gender symbol can indicate both a male and a female configuration.

In addition, the component cards 20 can include a polarity/signal tracer feature 85. This feature allows a user to visually trace one or more transmit/receive fiber pairs from one end of the channel link to the other end. To aid with the visual nature of this feature, the fibers can be individually colored. This feature may be helpful in visually validating the accuracy of the chosen components to ensure proper polarity. The component cards 20 can also include a title 90 which provides some identification of the product represented on the card and the type of a polarity method.

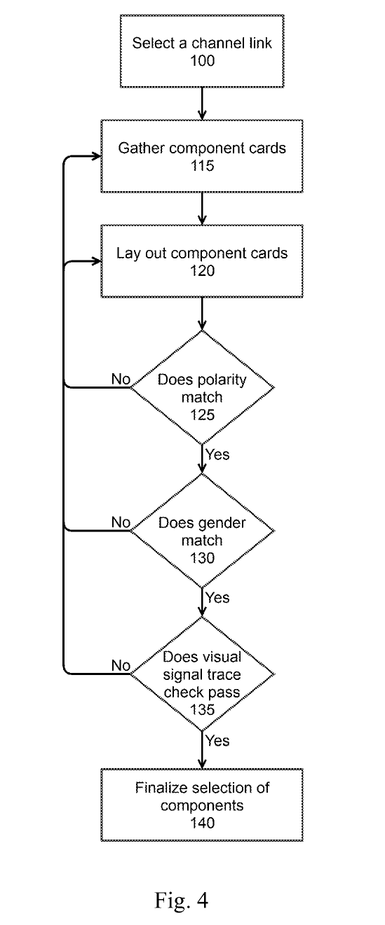

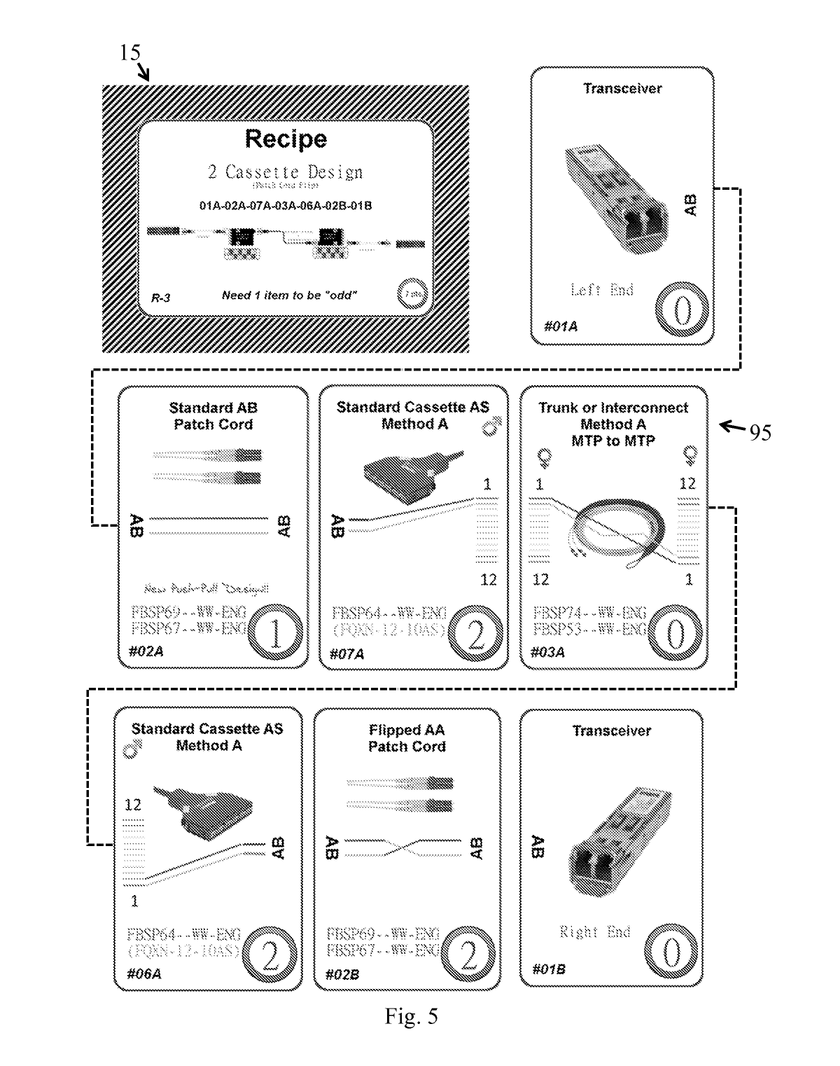

The recipe cards 15 and the component cards 20 can be used together to help enable an efficient and accurate selection of channel link components for a desired channel link. FIG. 4 illustrates a flow chart which represents a method of using the card deck according to an embodiment of the present invention. The steps of this flow chart are also described with reference to the cards shown in FIG. 5. In step 100, a user selects a particular channel link for implementation. This selection is done by way of choosing a particular channel link scenario shown/described in one of the recipe cards 15. To help with the selection, the user may rely on the graphical overview 25 of the channel and/or the card's title 50 which can provide at least some description of the channel link. Once a specific recipe card 15 with a particular channel link is selected, the user uses the card ID string 35 on selected recipe card to gather all needed component cards 20 in step 115 and lay the cards out in step 120. For the embodiment shown in FIG. 5, the recipe card includes a card ID string “01A-02A-07A-03A-06A-02B-01B.” This string indicates that the user needs component cards 20 with card ID numbers 01A, 02A, 07A, 03A, 06A, 02B, and 01B. Furthermore, the specific order of the card ID string 35 indicates the particular order in which the corresponding component cards 20 must be laid out in step 120. The layout of component cards which correspond to the card ID string of “01A-02A-07A-03A-06A-02B-01B” is shown in FIG. 5. Note that the user is not required to gather all needed component cards before beginning the layout in step 120. The user may, for example, lay the cards out as he or she comes across the correct cards while shuffling through the deck. The user may implement the described steps in any order so long as the final layout of the component cards 20 corresponds to the card ID string on the selected recipe card.

Upon the completion of step 120, the user can use the laid out channel link 95 for several purposes. The user can perform a polarity check in step 125. This can be done by summing all of the polarity counters 75 of the laid out channel link 95 to obtain a summed polarity value. An even number for the summed polarity value indicates a polarity mismatch which can signal the user to return back to either step 115 or 120 as a mistake in the gathering and/or layout of the cards has likely occurred. An odd number for the summed polarity value, on the other hand, indicates a polarity match which can signal that the polarity between two ends of the channel link is maintained.

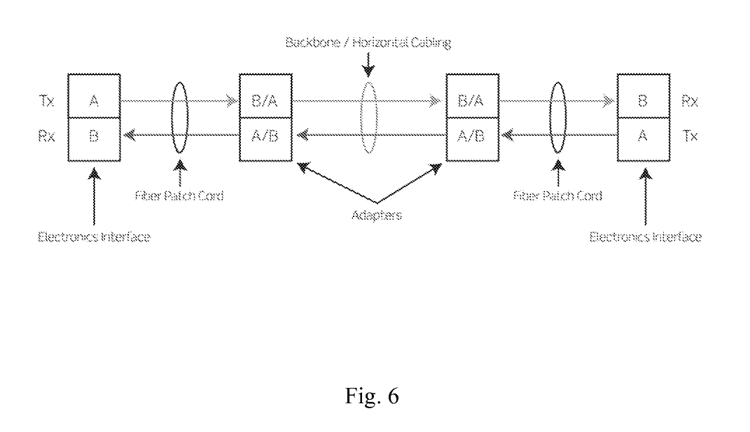

The polarity deck can operate based on the notion that in a polarity situation, some components within a fiber system can have one of two primary states—they can either change the polarity or they can maintain the polarity. Also, some other components are designed not to impact polarity (e.g., a patch panel). In an embodiment, components which have an MTP style connector on both ends are given a polarity counter value of “0,” and components having a non-MTP style connector (e.g., an LC connector) on at least one end thereof have a polarity counter value of “1” or “2.” For components with a polarity counter value of “1” or “2” the actual value is determined by whether a particular component is designed to maintain polarity or to change polarity. If a component is designed to maintain polarity, then it is assigned a value of “1”; if a component is designed to change polarity, then is it assigned a value of “2.” When referencing polarity, one can refer to “A” as a transmit port (Tx) at a first end which needs to be connected to “B” which is a receive (Rx) port on the opposite end. The diagram shown in FIG. 6 illustrates the standard naming convention. Connecting the two end-transceivers generally includes an odd number of components. For example, two transceivers can be connected via a single patch cord. In another example (shown in FIG. 6) two transceivers can be connected by three patch cords, all separated by two adapters (five components total). Alternatively, FIG. 6 can be viewed as two transceivers connected by two patch cords and a backbone cable, all separated by two adapters. As a result, if every element in the communication channel is a polarity maintaining component with an assigned value of “1,” the summation of these values will be an odd number. If, however, a polarity-changing component (with a polarity counter value of “2”) or an MTP-to-MTP component (with a polarity counter value of “0”) is introduced, such an introduction will terminate the correct maintenance of polarity and result in a summation of polarity values being an even number. To correct this scenario, a second component with a polarity counter value of “0” or “2” (e.g., a polarity-changing component) can be included and/or substituted in the communication channel to offset the initial polarity change, bringing the summation of polarity values back to an odd number. By examining the fiber paths for various components, it is possible to classify various components as described above to maintain accurate polarity configurations for various recipes.

In an embodiment, the aforementioned mechanics of the deck can be applied to any polarity method including, but not limited to, method A and method B polarity. Note that those of ordinary skill will be familiar with the standardized method A and method B polarity schemes, and therefore further discussion thereof is not necessary.

In addition to evaluating the parity of the summed polarity value, the obtained summed value can be compared to the polarity total 30 indicated on the respective recipe card 15. A mismatch between the summed value and the polarity total 30 can signify a mistake in the selection or the laying out of the channel link layout 95, and can signal the user to return to either step 115 or 120. Such a comparison can act as an additional confirmation check to help ensure that no component cards were missed in the channel link layout 95.

The user can also use the channel link layout 95 to perform a gender check in step 130 which can help verify the correctness of the gender between those connectors which may be gender limited. For example, given the male-to-female interaction (e.g., side-by-side positioning of gender symbols 80 in adjacent cards) between component cards having ID numbers 07A and 03A, and the female-to-male interaction between component cards having ID numbers 03A and 06A, the user is apprised of the appropriate interaction between the gender-limited connectors of the laid out channel link 95. Conversely, if the layout included male-to-male or female-to-female interactions between adjacent cards, such an occurrence would signal a potential gender incompatibility and the user would need to return back to either step 115 or 120 as a mistake in the gathering and/or layout of the cards has likely occurred. It should be noted that gender neutral indicators can serve to inform the user that a particular product can be configured to connect via a male, a female, or a combination male/female connector.

In addition, the user can perform a signal trace check in step 135. This can be done by visually following a signal which originates from one port of one of the transceivers (e.g., port A on the left end transceiver on card ID number 01A) through the entire channel link layout 95. The arrival of this signal in the complementary port (e.g., port B) of the remaining transceiver (e.g., the right end transceiver on card ID number 01B) further indicates proper wiring of the channel link with the indicated components.

Once the user completes the polarity, gender, and signal trace checks, the user is faced with a channel link layout 95 that includes a plurality of component cards 20 which represent respective channel link components. The user can then use the product ID 70 on each of the component cards as a means to order or obtain correct parts for implementing the desired channel link in the finishing step 140. This can help the user avoid potential confusion of ordering incompatible components, missing components from a multi-component order, or the like.

The channel link layout 95 can also be used during the implementation of the channel link by persons like installers. For example, the layout can provide a relatively simple reference for a list of parts needed for the installation. Likewise, the visual depiction and the particular order or the components within the layout can further assist in the installation process by providing a simple-to-follow reference manual.

Returning to the flow chart of FIG. 4, those skilled in the art will appreciate that steps 125, 130, and 135 can be performed in series or in parallel, and in any combination desired by the user. In other words, the user may wish to only perform a polarity check in step 125, only perform a gender check in step 130, or only perform a signal trace check in step 135 before determining that the channel link layout 95 is sufficiently accurate. Alternatively, the user may wish to perform only two of the three checks. Yet still, the user may wish to skip directly to the finishing step 140 without performing any particular checks.

It should also be appreciated that while a distinction between recipe cards and component cards has been made, a card ID string of any particular recipe card is not limited to reciting card ID numbers of only component cards. Instead, any card ID string can internally reference a card ID number of a second recipe card. In such a case, the second card ID string of the second recipe card is simply inserted into the first card ID string in a respective location of the second recipe card ID number.

Note that while this invention has been described in terms of several embodiments, these embodiments are non-limiting (regardless of whether they have been labeled as exemplary or not), and there are alterations, permutations, and equivalents, which fall within the scope of this invention. Additionally, the described embodiments should not be interpreted as mutually exclusive, and should instead be understood as potentially combinable if such combinations are permissive. Furthermore, it should be understood that any examples of cards shown herein are not intended to be limiting of the present invention. Instead, these cards are to be understood as exemplary, illustrating the generalized representation of the mechanics of the present invention according to only some of the embodiments. It should also be noted that there are many alternative ways of implementing the methods and apparatuses of the present invention. It is therefore intended that claims that may follow be interpreted as including all such alterations, permutations, and equivalents as fall within the true spirit and scope of the present invention.

I claim:

1. A deck of cards for implementing a communication channel link, comprising:
a plurality of recipe cards, each of said plurality of recipe cards including an overview of said communication channel link, a card ID string, and a polarity total; and
a plurality of component cards, each of said plurality of component cards including a card ID number, a product ID, and a polarity counter,
wherein said card ID string comprises said card ID numbers of at least some of said plurality of component cards.

2. The deck of claim 1, wherein said communication channel link is at least one of a duplex fiber optics channel link and a parallel fiber optics channel link.

3. The deck of claim 2, wherein said plurality of component cards further include a signal trace feature, said signal trace feature including a graphical depiction of at least one transmit optical fiber and at least one corresponding receive optical fiber of said communication channel link.

4. The deck of claim 1, wherein said overview includes a graphical depiction of individual components of said communication channel link.

5. The deck of claim 1, wherein said polarity counter is a numerical value of 0, 1, or 2, and wherein for any said recipe card respective said polarity total is a summation of polarity counters of all said component cards of respective said card ID string.

6. The deck of claim 1, wherein at least some of said plurality of component cards further include at least one of a male gender symbol and a female gender symbol.

7. The deck of claim 1, wherein said product ID includes at least one of a part number, a specification sheet number, and a QR (quick response) code.

8. The deck of claim 1, wherein plurality of component cards further include a product descriptor, said product descriptor being a graphical depiction of a component which corresponds to respective said product ID.

9. A method of selecting components for a communication channel link, said method comprising the steps of:
selecting said communication channel link from a presented plurality of available communication channel links;
associating said selected communication channel link with a card ID string, said card ID string including a plurality of card IDs, each of said card IDs corresponding to one of a plurality of component cards, each of said plurality of component cards including at least some information related to at least one of said components and a polarity counter;
compiling said plurality of component cards; and
selecting said components from said compiled plurality of component cards.

10. The method of claim 9, further comprising the step of using said polarity counters to determine one of proper polarity and improper polarity within said communication channel link.

11. The method of claim 10, wherein said step of determining includes a summation of said polarity counters, said polarity being proper when said summation is an odd number and said polarity being improper when said summation is an even number.

12. The method of claim 11, wherein said selected communication channel link includes a polarity total, and wherein said step of determining further includes a comparison of said summation to said polarity total, said polarity being proper when said summation is equal to said polarity total and said polarity being improper when said summation is not equal to said polarity total.

13. The method of claim 11, wherein the step of compiling said plurality of component cards includes laying out said component cards in an order defined in said card ID string.

14. The method of claim 13 further including the step of performing a gender check, wherein at least some of said component cards include one of a male symbol, a female symbol, and a male/female symbol, and wherein said gender check is satisfied if any two adjacent said symbols on respective adjacent said component cards include only said male symbols, only said female symbols, or one said male/female symbol.
